(19) United States
(12) Patent Application Publication
(10) Pub. No.: US 2020/0102489 A1
(43) Pub. Date: Apr. 2, 2020

(54) METHODS FOR IMPROVED OR ENHANCED OIL RECOVERY

(71) Applicant: Naveed Aslam, Bellaire, TX (US)

(72) Inventor: Naveed Aslam, Bellaire, TX (US)

(21) Appl. No.: 16/148,173

(22) Filed: Oct. 1, 2018

(51) Int. Cl. C09K 8/594; C09K 8/588; E21B 43/16

(52) U.S. Cl. CPC C09K 8/594; E21B 43/168; C09K 8/588

(57) ABSTRACT

A method for the enhanced recovery of oil from a hydrocarbon-containing reservoir is disclosed. A mixture of Y-Grade materials, nitrogen and a cross-linking agent is fed to the hydrocarbon-containing reservoir either as a mixture or in the form of a foam. The cross-linking agent such as high molecular weight polyethylene will assist in increasing the viscosity of the mixture of Y-Grade materials and nitrogen and assist in providing improved performance at oil recovery in the reservoir.

### BACKGROUND OF THE INVENTION

During enhanced oil recovery operations, additives can be added to the hydrocarbons present in an oil reservoir to assist in recovering the hydrocarbons. For example, raw natural gas liquids such as Y-Grade hydrocarbons are added with nitrogen to hydrocarbons in reservoirs to assist in the recovery of the hydrocarbons. These additive combinations may be added in the form of foam to assist in their introduction into the hydrocarbons.

One problem with the introduction of these additives as a foam or their natural state is that they are less dense than the hydrocarbons that are present in the reservoir. This can cause problems because the additive will float to the top of the hydrocarbons in the reservoir and will be less effective in assisting in recovering hydrocarbons.

The additives, particularly when in the form of a foam will buoy upwards at the injection point due to the differences in the densities of the reservoir fluids and the foam. As a result of this buoyancy effects, no miscibility layer is created and the additives remain as a separate upper layer thereby not contacting the majority of the reservoir fluids.

The lighter nitrogen Y-Grade mixture foams will tend to segregate themselves in the upper regions of a reservoir thereby lowering their overall effectiveness at enhanced oil recovery which can produce two issues for enhanced oil recovery applications, namely low density and low viscosity.

Accordingly, the methods of the present invention are designed to address this shortcoming and improve the enhanced recovery of oils from hydrocarbon-bearing reservoirs.

### SUMMARY OF THE INVENTION

In a first embodiment of the invention, there is disclosed a method for enhanced oil recovery in a hydrocarbon reservoir by feeding a mixture of nitrogen, Y-Grade materials and a cross-linking agent to the hydrocarbon reservoir.

In another embodiment of the invention, there is disclosed a method for enhanced oil recovery in a hydrocarbon reservoir comprising feeding a foam mixture of Y-Grade materials, nitrogen and a cross-linking agent to the hydrocarbon reservoir.

The enhanced oil recovery is performed on a reservoir that contains hydrocarbons. The enhanced oil recovery will assist in recovering more hydrocarbons from the reservoir.

The enhanced oil recovery methods may be employed in either a conventional or unconventional reservoir.

The cross-linking agent can be a single cross-linking agent or could be a mixture of cross-linking agents. The cross-linking agent should interact with the natural gas liquids and enhance the viscosity of the nitrogen based natural gas liquid foam.

For purposes of the present invention, the cross-linking agents can be selected from three broad classes of materials, namely high molecular weight polymers, small associating molecules and hydrocarbon polymers. These materials overcome certain of the challenges that are faced by solvents in hydrocarbons in reservoirs. Alkanes are poor solvents for polymers. They typically have low solubility in ethane, for example, and therefore difficult to dissolve in ethane at reservoir conditions.

The viscosity of the natural gas liquids that comprise the Y-Grade materials must increase at laminar flow conditions to be effective in enhanced oil recovery or fracking applications.

The cross-linking agents useful in the methods of the present invention particularly are selected from the group consisting of polyethylene having a molecular weight 108,246 in ethane, polyethylene having a molecular weight of 340,000 in propane, polyethylene having a molecular weight of 420,000 in butane, polyethylene 10-methacrylate having a molecular weight of 100,000, poly-alpha-olefins, polyethylene-oxide, polyisopropene, polyisobutylene, ethyl cellulose, and ethylene vinyl alcohol.

The cross-linking agents can be added to the Y-Grade materials as individual molecules or in mixtures of two or more cross-linking agents. This will allow the operator greater flexibility and tunability with respect to achieving the right composition for the unique properties of an individual reservoir.

For example, certain cross-linking agents may be more suited for certain reservoir conditions such as pressure, temperature and/or salinity, while other cross-linking agents may be better for shallow, lower temperature and/or lower pressure hydrocarbon formations. Oxygenate based hydrocarbon cross-linking agents such as those based on poly-vinyl acetate and poly-vinyl alcohol could be stable at high, pressure, high temperature and higher salinity reservoir conditions, and would therefore be a good choice for use as a cross-linking agent under those conditions.

These cross-linking agents can potentially increase the viscosity of natural gas liquids foam by a factor of 25 to 30.

The small associating molecules can be cross-linking phosphate esters which can increase the viscosity of the natural gas liquid foam by a factor of 24 to 27.

The mixture of Y-Grade material, nitrogen and cross-linking agent is typically formed by solubilizing the cross-linking agent in the Y-Grade materials. This is typically done through either in-line mixing or dosing into the Y-Grade materials storage tank or through the Y-Grade delivery pipe. It is preferable to add the cross-linking agents to the Y-Grade materials to minimize losses due to interactions with rock and formation water.

Any solvent material then that would improve the dispersion of and dissolution of the cross-linking agents into the Y-Grade materials could be employed. The cross-linking agents can be dissolved in a suitable solvent such as methanol or butanol before being dissolved into the Y-Grade materials. Pentane may also be employed as a solvent material.

Typically, the cross-linking agents are added in an amount ranging from about 100 to about 2000 parts per million parts of Y-Grade materials.

The Y-Grade materials can be pumped into a reservoir through a Y-Grade quality pump. Typically, the Y-Grade materials are stored at the reservoir on-site or are piped through. However, reservoir pressure could be higher than the pipe or storage vessel pressure so the Y-Grade materials need to be pumped up to a higher pressure to be delivered downhole through reservoir injection arrangements. To that extent it would assist in this delivery process,

### DETAILED DESCRIPTION OF THE INVENTION

The mixture of nitrogen and Y-Grade materials is typically in a ratio of 90:10 or 50:50. The mixture of the three ingredients, Y-Grade materials, nitrogen and cross-linking agent can be added to the hydrocarbon reservoir in either a non-foam or foam form.

The foam can thus be prepared by injecting a mixture of the Y-Grade materials and the cross-linking agent into the hydrocarbon reservoir and then injecting the nitrogen which will cause foam to form. While this mixture can be created before feeding into the hydrocarbon reservoir, it is preferable to form the foam by the above injection technique.

In general, Y-grade materials are natural gas liquids and comprise: ethane, wherein the ethane comprises about 30% to 80% of the fluid; propane, wherein the propane comprises about 15% to 50% of the fluid; butane, wherein the butane comprises about 15% to 45% of the fluid; isobutane, wherein the isobutane comprises about 15% to 40% of the fluid; and pentane plus, wherein the pentane plus comprises about 5% to 25% of the fluid.

The crosslinking will create a secondary network inside the Y-Grade materials such that the low viscosity liquids that comprise the Y-Grade materials could have enhanced viscosity. An advantage is that the cross-linking agent can be added at relatively low concentrations which provides a greater tunability to preparing the mixture of Y-Grade materials, nitrogen and cross-linking agent. This range of tunability allows an operator to provide the appropriate mixture and appropriate viscosity depending upon the nature of the hydrocarbons, size and physical structure of the reservoir, and other conditions.

The mixture of nitrogen and Y-Grade materials particularly in foam form have low density and low viscosity with respect to the hydrocarbons that are present in a hydrocarbon reservoir where enhanced oil recovery is being undertaken. The range of crude oil viscosity values associated with most hydrocarbons is 1 to 2 mPa-s (7 to 140 mPa) in the United States. For Canada, the crude oil viscosity values range from 0.1 to 0.8 mPA-s.

The Y-Grade material is 0.1 centipoise (cp) while the nitrogen gas is 0.025 cp. A 90-10 mixture is 0.03344 cp. Clearly, the viscosity of the nitrogen based Y-Grade material foam is considerably lower than the hydrocarbons present in the reservoir. This lower viscosity can cause several problems in an enhanced oil recovery operation. Viscous fingering can occur. An early breakthrough of the natural gas liquids that comprise the Y-Grade materials. Unnecessarily high usage of the natural gas liquids can result. This can result in high gas to oil ratios. These negatives can all contribute to poor sweep efficiency and depressed oil production thereby resulting in a lower percent of oil recovered.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for enhanced oil recovery in a hydrocarbon reservoir by feeding a mixture of nitrogen, Y-Grade materials and a cross-linking agent to the hydrocarbon reservoir.

2. The method as claimed in claim 1 wherein the cross-linking agent is selected from the group consisting of polyethylene having a molecular weight 108,246 in ethane, polyethylene having a molecular weight of 340,000 in propane, polyethylene having a molecular weight of 420,000 in butane, polyethylene 10-methacrylate having a molecular weight of 100,000, poly-alpha-olefins, polyethylene-oxide, polyisopropene, polyisobutylene, ethyl cellulose, and ethylene vinyl alcohol.

3. The method as claimed in claim 1 wherein the cross-linking agent is a cross-linking phosphate ester.

4. The method as claimed in claim 1 wherein the cross-linking agent comprises a mixture of cross-linking agents.

5. The method as claimed in claim 1 wherein the cross-linking agent increases viscosity of the Y-Grade materials by a factor of 25 to 30.

6. The method as claimed in claim 1 wherein the cross-linking agent is first fed into the Y-Grade materials before mixing with the nitrogen.

7. The method as claimed in claim 1 wherein the Y-Grade materials and the cross-linking agent are mixed with the nitrogen in the hydrocarbon reservoir.

8. The method as claimed in claim 1 wherein the mixture is in the form of a foam.

9. The method as claimed in claim 8 wherein the foam is formed by a method selected from the group consisting of forming the foam before feeding into the reservoir and forming the foam in the reservoir.

10. The method as claimed in claim 1 wherein the hydrocarbon reservoir is selected from the group consisting of a conventional reservoir and an unconventional reservoir.

11. A method for enhanced oil recovery in a hydrocarbon reservoir comprising feeding a foam mixture of Y-Grade materials, nitrogen and a cross-linking agent to the hydrocarbon reservoir.

12. The method as claimed in claim 11 wherein the cross-linking agent is selected from the group consisting of polyethylene having a molecular weight 108,246 in ethane, polyethylene having a molecular weight of 340,000 in propane, polyethylene having a molecular weight of 420,000 in butane, polyethylene 10-methacrylate having a molecular weight of 100,000, poly-alpha-olefins, polyethylene-oxide, polyisopropene, polyisobutylene, ethyl cellulose, and ethylene vinyl alcohol.

13. The method as claimed in claim 11 wherein the cross-linking agent is a cross-linking phosphate ester.

14. The method as claimed in claim 11 wherein the cross-linking agent is a cross-linking phosphate ester.

15. The method as claimed in claim 11 wherein the cross-linking agent comprises a mixture of cross-linking agents.

16. The method as claimed in claim 11 wherein the cross-linking agent increases viscosity of the Y-Grade materials by a factor of 25 to 30.

17. The method as claimed in claim 11 wherein the cross-linking agent is first fed into the Y-Grade materials before mixing with the nitrogen.

18. The method as claimed in claim 11 wherein the Y-Grade materials and the cross-linking agent are mixed with the nitrogen in the hydrocarbon reservoir.

19. The method as claimed in claim 11 wherein the foam mixture is fed to the reservoir by a pump.

20. The method as claimed in claim 11 wherein the hydrocarbon reservoir is selected from the group consisting of a conventional reservoir and an unconventional reservoir.
